(19) United States
(12) Patent Application Publication
(10) Pub. No.: US 2004/0018778 A1
(43) Pub. Date: Jan. 29, 2004

(54) Systems and methods for connecting components in an entertainment system

(76) Inventors: Walter Easterbrook, Hancock, NY (US); John E. Harrity, Centreville, VA (US)

Correspondence Address: John E. Harrity, Suite 300, 11240 Waples Mill Road, Faifax, VA, 22030, US

(21) Appl. No.: 10/241,655

(22) Filed: Sep. 12, 2002

Related U.S. Application Data
(60) Provisional application No. 60/397,602, filed on Jul. 23, 2002.

(51) Int. Cl. H01R 24/00; H01R 33/00

(52) U.S. Cl. 439/701; 439/660

(57) ABSTRACT

A connector unit connects a television and a group of components in an entertainment system. The connector unit includes at least two first connectors, where each of the first connectors is configured to receive a different type of signal cable from a television, at least one second connector configured to receive a signal cable from one of the group of components, and at least one third connector configured to receive a signal cable from a second of the group of component.

### RELATED APPLICATION

This application claims priority under 35 U.S.C. § 119 based on U.S. Provisional Application No. 60/397,602, filed Jul. 23, 2002, the disclosure of which is incorporated herein by reference.

### FIELD OF THE INVENTION

The present invention relates generally to entertainment systems and, more particularly, to systems and methods for connecting a group of components to a television.

### BACKGROUND OF THE INVENTION

Interconnecting components in an entertainment system has always been a difficult endeavor for even the most learned individual. This is especially true when individuals seek to interconnect a large number of components. For example, it is quite common for individuals to desire to connect cable or satellite receivers, video cassette recorders (VCRs), digital video disk (DVD) players, camcorders, video game consoles, surround sound systems, computers, and the like to a television set. People often struggle, however, determining what type(s) of cables to use (e.g., coaxial cables, S video cables, 3 RCA cables, etc.) to interconnect all of these components and where on these different components to connect the cables. As a result, people often require assistance from an experienced individual to properly connect the entertainment components.

In some instances, the components in a person's entertainment system may only accept specific types of cables. For example, an older television set may only include a connector for receiving a coaxial cable. Newer components, such as DVD players, video game consoles, and the like, however, may only include connectors for receiving an S video cable and/or a 3 RCA cable. To properly connect the newer components to the older television set, the individual would be required to purchase specialized splitters and adapters for routing signals been the non-analogous connectors. Again, people often require the assistance of an experienced individual to make these types of interconnections.

Therefore, there exists a need for systems and methods that facilitate the interconnection of components in an entertainment system.

### SUMMARY OF THE INVENTION

Systems and methods consistent with the present invention address this and other needs by providing a mechanism that allows for components in an entertainment system to be easily interconnected.

In accordance with the purpose of this invention as embodied and broadly described herein, a system for routing signals in an entertainment system is disclosed. The system includes one or more television connectors, one or more cable/satellite receiver connectors, one or more video cassette recorder connectors, one or more digital video disk connectors, and a converter unit. The television connectors are configured to receive one or more connector cables from a television. The cable/satellite receiver connectors are configured to receive one or more connector cables from one of a cable receiver and satellite receiver. The video cassette recorder connectors are configured to receive one or more connector cables from one or more video cassette recorders. The digital video disk connectors are configured to receive one or more connector cables from a digital video disk device. The converter unit is configured to format signals for transmission amongst the television, the cable or satellite receiver, the one or more video cassette recorders, and the digital video disk device.

In another implementation consistent with the present invention, a system for routing signals in an entertainment system is provided. The system includes one or more first connectors, one or more second connectors, one or more third connectors, and a converter unit. The one or more first connectors receive one or more connector cables from a first entertainment component. The one or more second connectors receive one or more connector cables from a second entertainment component. The one or more third connectors receive one or more connector cables from a third entertainment component. The converter unit converts signals received via one of the first, second, and third connectors from a first format to one or more different formats, and routes the signals between the first, second, and third connectors.

In yet another implementation consistent with the present invention, a method for interconnecting a group of components in an entertainment system is provided. The method includes connecting a television to a connector unit, connecting the group of components to the connector unit, and routing signals between the group of components and the television via the connector unit.

In a further implementation consistent with the present invention, a method for routing signals via a connector unit configured to interconnect a television and a plurality of components is provided. The method includes receiving one or more signals in a first format from one of the plurality of components, converting the one or more signals from the first format to one of a plurality of different formats, and transmitting the one or more signals in the different format to the television.

In still a further implementation consistent with the present invention, a connector unit for use in an entertainment system including a television and a group of components is provided. The connector unit includes at least two first connectors, where each of the first connectors is configured to receive a different type of signal cable from a television, at least one second connector configured to receive a signal cable from one of the group of components, and at least one third connector configured to receive a signal cable from a second of the group of component.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 illustrates an exemplary system in which systems and methods, consistent with the present invention, may be implemented;

FIG. 2 illustrates an exemplary configuration of the connector unit of FIG. 1 in an implementation consistent with the present invention;

FIG. 3 illustrates an exemplary functional block diagram of the connector unit of FIG. 1;

FIG. 4 illustrates an exemplary alternative functional block diagram of the connector unit of FIG. 1; and

FIG. 5 illustrates an exemplary process for connecting components to a television in an implementation consistent with the present invention.

### DETAILED DESCRIPTION

The following detailed description of implementations consistent with the present invention refers to the accompanying drawings. The same reference numbers in different drawings may identify the same or similar elements. Also, the following detailed description does not limit the invention. Instead, the scope of the invention is defined by the appended claims and their equivalents.

Implementations consistent with the present invention provide a connector device for interconnecting components of an entertainment system. The connector unit includes a group of connectors that are separated by the component to which the connectors should be connected. For example, the connectors for connecting to a television are separated from the connectors for a cable/satellite receiver, DVD player/recorder, VCR, and other common peripheral components. The connector unit formats signals transmitted between the components of the entertainment system based on the particular cables with which the components are connected to the connector unit thereby allowing the components of the entertainment system to be easily interconnected.

### Exemplary System

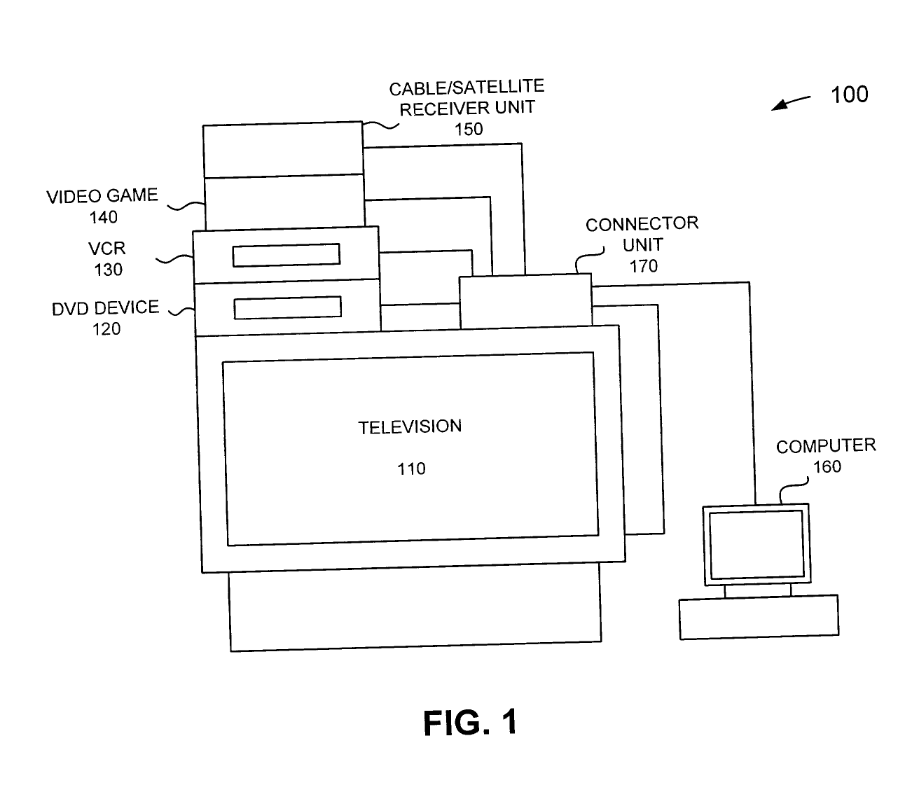

FIG. 1 illustrates an exemplary system 100 in which systems and methods, consistent with the present invention, may be implemented. System 100 includes a television 110, a DVD device 120, a VCR 130, a video game device 140, a cable/satellite receiver unit 150, a computer 160, and a connector unit 170. The number of components illustrated in FIG. 1 has been shown for simplicity. It will be appreciated that a typical system may include more or fewer components than illustrated in FIG. 1. Moreover, it will be appreciated that system 100 may include other devices that may connect to a television, such as a surround sound system, a camcorder, or the like, not illustrated in FIG. 1.

Television 110 may include any type of conventional television capable of presenting video and/or audio signals to a user. Alternatively, television 110 may include one or more display devices, such as a computer display, capable of displaying video to a user. Television 110 may include one or more connectors for transmitting and/or receiving video and/or audio signals. For example, television 110 may include a coaxial cable connector, an S video cable connector, and/or a 3 RCA cable connector that allows the television to transmit/receive video and/or audio signals via a coaxial cable, S video cable, and 3 RCA cable, respectively.

DVD device 120 may include one or more conventional DVD players capable of playing DVDs or compact disks. DVD device 120 may also include a DVD recorder capable of recording video and audio to a compact disk. DVD device 120 may include one or more connectors for transmitting/receiving video and audio signals. For example, DVD device 120 may include an S video cable connector and/or a 3 RCA cable connector.

VCR 130 may include any conventional VCR device capable of playing and/or recording video and audio signals. VCR 130 may include one or more connectors for transmitting/receiving video and audio signals. For example, VCR 130 may include a coaxial cable connector, an S video cable connector, and/or a 3 RCA cable connector.

Video game device 140 may include any conventional video game device, such as those produced by Sony™ and Nintendo™. Video game device 140 may include one or more connectors for transmitting video and audio signals. For example, video game device 140 may include a coaxial cable connector and/or a 3 RCA cable connector.

Cable/satellite receiver unit 150 may include any conventional cable and/or satellite receiver unit. Cable/satellite receiver unit 150 may include one or more connectors for transmitting video and audio signals. For example, cable/satellite receiver unit 150 may include a coaxial cable connector, an S video cable connector, and/or a 3 RCA cable connector.

Computer 160 may include a desktop computer, laptop, or any other type of computer device. Computer 160 may include one or more connectors for transmitting and/or receiving video and audio signals. For example, computer 160 may include an S video connector.

Connector unit 170 facilitates the interconnection of the components 110-160 of system 100. Connector unit 170 may include a group of connectors capable of interconnecting television 110, DVD device 120, VCR 130, video game unit 140, cable/satellite receiver unit 150, and computer 160. As will be described in detail below, connector unit 170 separates the connectors for the different components 110-160 of system 100 so as to aid a user in connecting the components 110-160. Connector unit 170 may also include a group of converters for converting signals between different formats. For example, connector 170 may convert signals transported over a coaxial cable to the appropriate format for transport over S video cables, 3 RCA cables, or other types of cables.

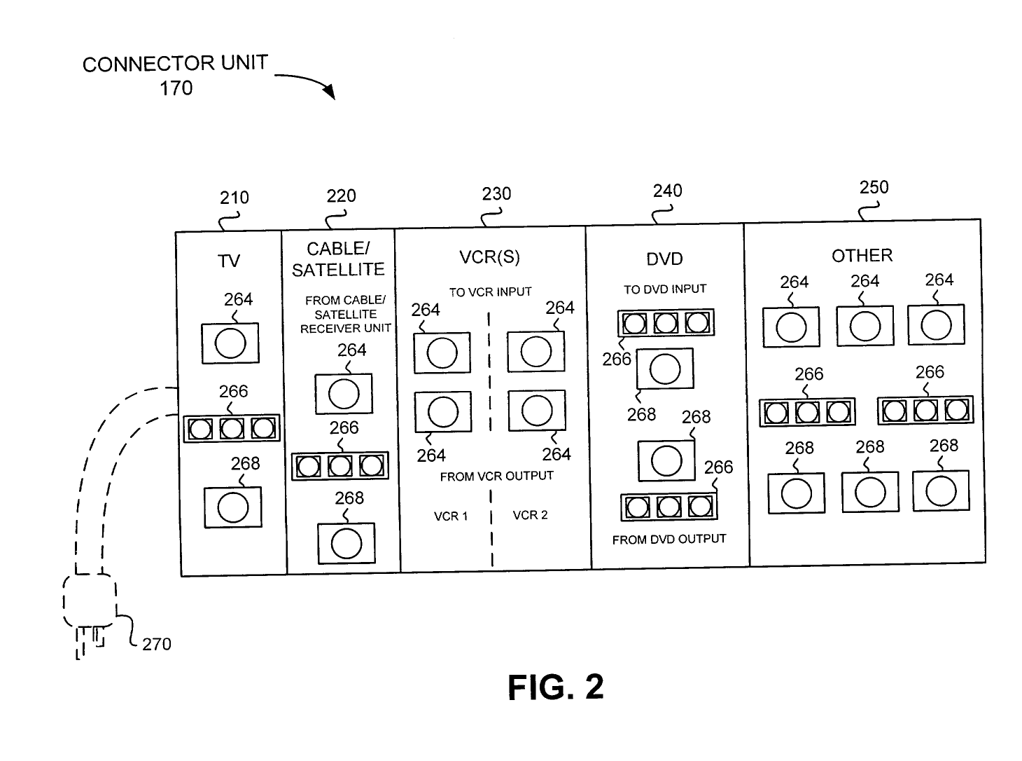

FIG. 2 illustrates an exemplary configuration of connector unit 170 of FIG. 1 in an implementation consistent with the present invention. As illustrated, connector unit 170 may include a set of television connectors 210, a set of cable/satellite connectors 220, a set of VCR connectors 230, a set of DVD connectors 240, other sets of connectors 250, and an optional power cord 270. Power cord 270 allows connector 170 to be connected to a power supply. Alternatively, connector 170 may include a battery power supply (or some other type of power supply) or may not include any power supply. In such situations, connector 170 may not include power cord 270.

Television connector set 210 may include one or more connectors for interconnecting television 110 to connector unit 170. The connectors may include, for example, a coaxial cable connector 264, a 3 RCA cable connector 266, and an S video cable connector 268. Coaxial cable connector 264 is capable of receiving a coaxial cable. 3 RCA cable connector 266 is capable of receiving a 3 RCA cable. S video cable connector 268 is capable of receiving an S video cable.

Cable/satellite connector set 220 may include one or more connectors for interconnecting cable/satellite receiver unit 150 to connector unit 170. The connectors may include, for example, a coaxial cable connector 264, a 3 RCA cable connector 266, and an S video cable connector 268. VCR connector set 230 may include connectors for interconnecting one or more VCRs 130 to connector unit 170. The connectors may include, for example, coaxial cable connectors 264, 3 RCA cable connectors (not shown), and S video cable connectors (not shown). Coaxial cable connectors 264 may include connectors via which video and audio signals are transmitted to VCR 130 and connectors via which video and audio signals are received from VCR 130. Connector unit 170 may facilitate the connection of the appropriate coaxial cables to the appropriate coaxial cable connectors 264 by indicating on connector unit 170 where the cables are to be connected. For example, connector unit 170 may include labeling, such as “TO VCR INPUT” and “FROM VCR OUTPUT,” to aid a user in interconnecting connector unit 170 and VCR 130. In an alternative implementation, VCR connector set 230 (and the other sections 210, 220, 240, and 250) of connector unit 170 may include color coding (in addition to or as an alternative to labeling) to facilitate the connection of cables to the appropriate location on connector unit 170.

DVD connector set 240 may include one or more connectors for interconnecting DVD device 120 to connector unit 170. The connectors may include, for example, 3 RCA cable connectors 266 and S video cable connectors 268. When DVD device 120 includes recording capabilities, connector unit 170 may include separate connectors for receiving video and audio signals from DVD device 120 and separate connectors for transmitting video and audio signals to DVD device 120. In such a situation, connector unit 170 may include labeling, such as “TO DVD INPUT” and “FROM DVD OUTPUT,” to aid a user in interconnecting DVD device 120 and connector unit 170. Alternatively, a single connector may transport video and audio signals between DVD device 120 and connector unit 170.

Other connector set 250 may include one or more connectors for interconnecting other entertainment components, such as a video game unit 140, a computer 160, a camcorder, a surround sound system, and the like, to connector unit 170. The connectors may include, for example, one or more coaxial cable connectors 264, one or more 3 RCA cable connectors 266, one or more S video cable connectors 268, or other types of connectors.

It will be appreciated that by labeling the different sections of connector unit 170 in the manner illustrated in FIG. 2 facilitates the connection of cables to connector unit 170. For example, a user could readily determine that a coaxial cable from a television, such as television 110, should be connected to the appropriate connector in television connector set 210. Alternatively, color coding may be used to facilitate the connection of cables to connector unit 170. The number and types of connectors in each connector set 210-250 have been provided for simplicity. It will be appreciated that connector unit 170 may include more or fewer connectors or other types of connectors than illustrated in FIG. 2.

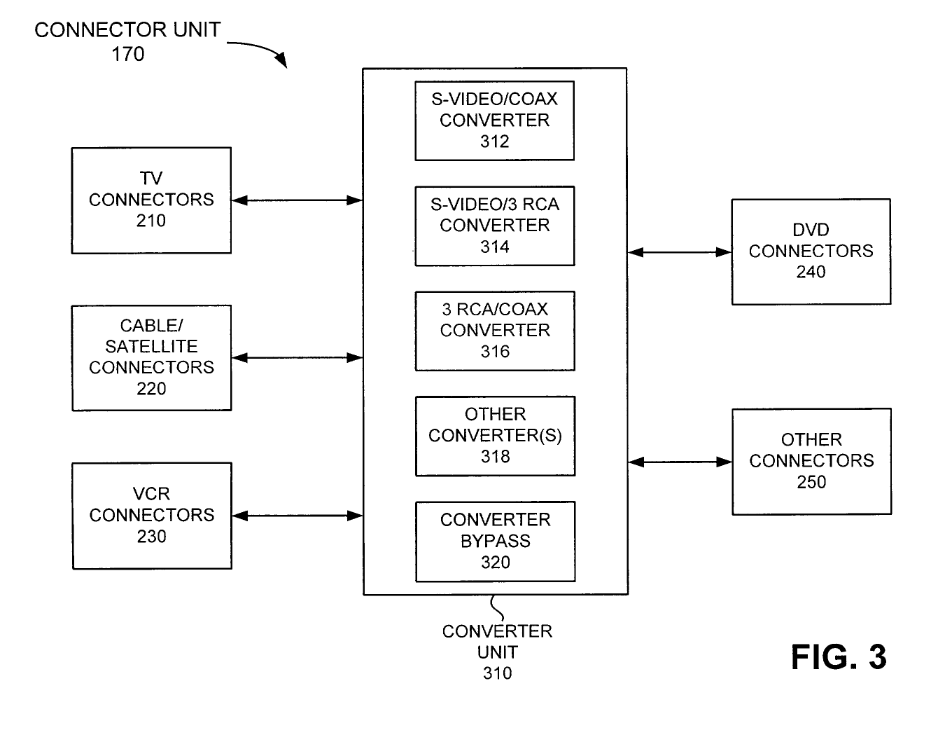

FIG. 3 illustrates an exemplary functional block diagram of connector unit 170 of FIG. 1. As illustrated, connector unit 170 may include television (TV) connectors 210, cable/satellite connectors 220, VCR connectors 230, DVD connectors 240, other connectors 250, and a converter unit 310. As set forth above, TV connectors 210, cable/satellite connectors 220, VCR connectors 230, DVD connectors 240, and other connectors 250 may include coaxial cable connectors, 3 RCA cable connectors, S video cable connectors, and/or other conventional types of connectors.

Converter unit 310 may include an S video/coax converter 312, an S video/3 RCA converter 314, a 3 RCA/coax converter 316, other converters 318, and a converter bypass unit 320. S video/coax converter 312 formats signals transmitted over an S video cable for transmission over a coaxial cable, and vice versa, using well-known techniques. S video/3 RCA converter 314 formats signals transmitted over an S video cable for transmission over a 3 RCA cable, and vice versa, using well-known techniques. 3 RCA/coax converter 316 formats signals transmitted over a 3 RCA cable for transmission over a coaxial cable, and vice versa, using well-known techniques. Other converters 318 may include one or more converters that format signals for transmission between other types of conventional cables. Converter bypass unit 320 transports signals between similar connectors. For example, converter bypass unit 320 may transport signals between a coaxial connector of VCR connectors 230 and a coaxial connector of TV connectors 210.

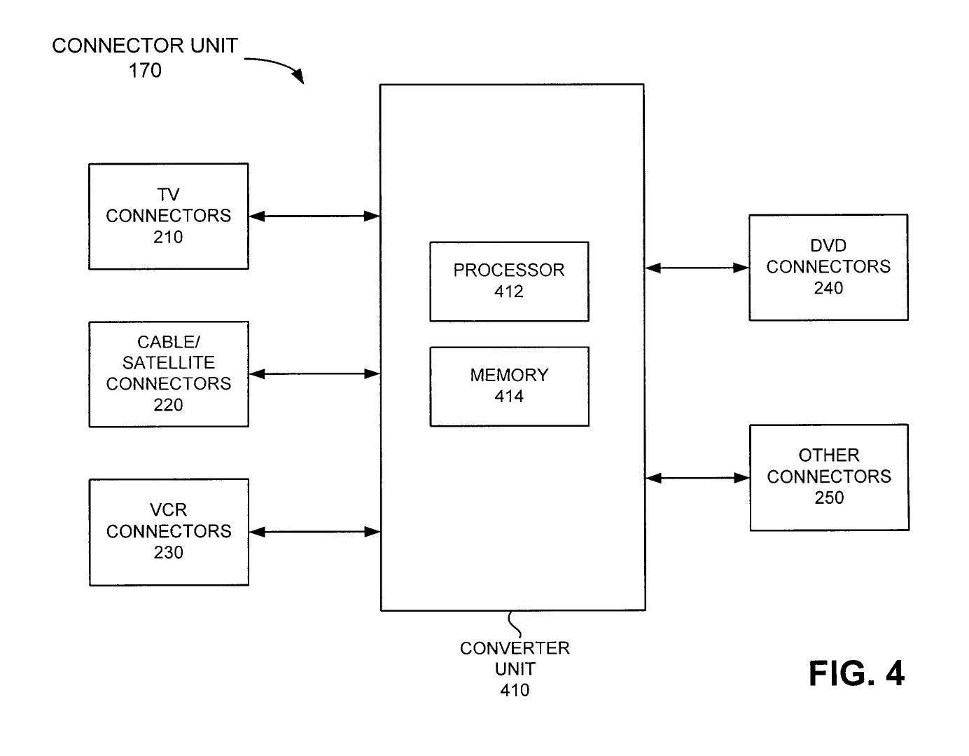

FIG. 4 illustrates an alternative exemplary functional block diagram of connector unit 170 of FIG. 1. As illustrated, connector unit 170 may include TV connectors 210, cable/satellite connectors 220, VCR connectors 230, DVD connectors 240, other connectors 250, and a converter unit 410. As set forth above, TV connectors 210, cable/satellite connectors 220, VCR connectors 230, DVD connectors 240, and other connectors 250 may include coaxial cable connectors, 3 RCA cable connectors, S video cable connectors, and/or other conventional types of connectors.

In this implementation, converter unit 410 may include a processor 412 and a memory 414. Processor 412 may include any type of conventional processor or microprocessor that interprets and executes instructions. Memory 414 may include a random access memory (RAM) or another type of dynamic storage device that stores information and instructions for execution by processor 412 and/or a read only memory (ROM) or another type of static storage device that stores static information and instructions for use by processor 412.

Processor 412 performs the functions described above with respect to converters 312-318 and converter bypass unit 320. That is, processor 412 receives signals from a connector, formats the signals (if necessary), and forwards the signals to the appropriate destination connector. For example, assume that DVD device 120 transmits signals to television 110. Assume further that DVD device 120 connects to connector unit 170 via an S video cable and that television 110 connects to connector unit 170 via a coaxial cable. In such a situation, processor 412 may receive signals from an S-video connector 268 of DVD connector set 240, format the signals for transmission via a coaxial cable, and forward the signals to a coaxial connector 264 of television connector set 210.

### Exemplary Processing

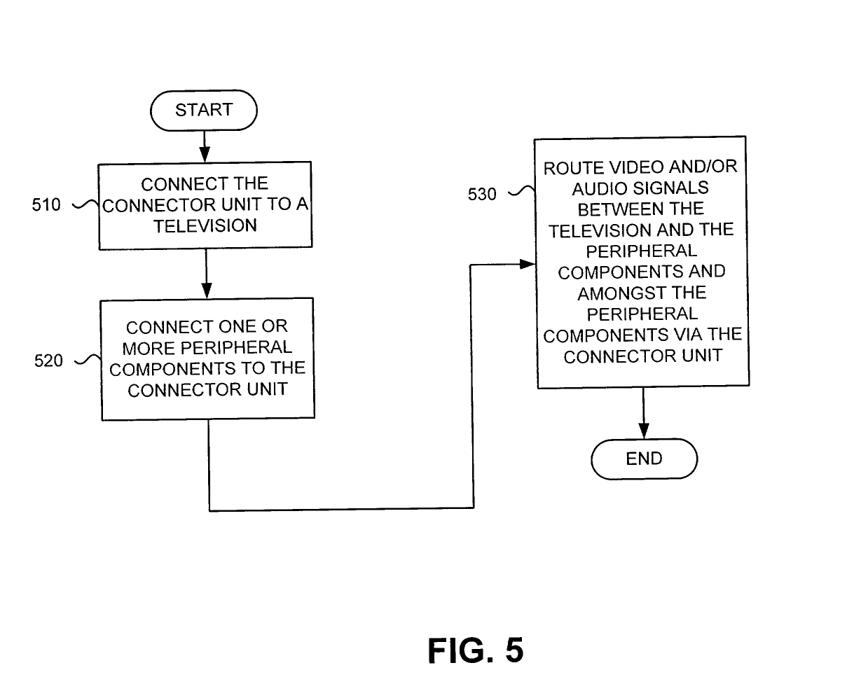

FIG. 5 illustrates an exemplary process for connecting components to a television in an implementation consistent with the present invention. Processing may begin by connecting a television, such as television 110, to connector unit 170 [act 510]. As described above, television 110 may, for example, connect to an appropriate connector of television connector set 210 of connector unit 170 via a coaxial cable, 3 RCA cable, an S video cable, or some other similar type of cable. Other peripheral components may be connected to connector unit 170 [act 520]. These peripheral components may include, for example, DVD device 120, VCR 130, video game unit 140, cable/satellite receiver unit 150, computer 160, a surround sound system, camcorder, or the like. Each of these peripheral components may connect to connector unit 170 via a coaxial cable, 3 RCA cable, S video cable, or another similar type of cable. As an example, DVD device 120 may connect to connector unit 170 via an S video cable. To connect DVD device 120, a user may connect an S video cable to the appropriate output of DVD device 120 and connect the other end of the S video cable to S video connector 268 of DVD connector set 240.

Once television 110 and the desired peripheral components are connected to connector unit 170, connector unit 170 may route video and/or audio signals between television 110 and the peripheral components and amongst the peripheral components, such as between cable/satellite receiver unit 150 and VCR 130 [act 530]. As described above, the routing of signals between the devices connected to connector unit 170 may involve formatting the signals for transmission via the appropriate connection cable. For example, connector unit 170 may format a signal received from a coaxial cable for transmission over an S video cable.

In some situations, several peripheral components may attempt to transmit signals to television 110 (or some other component) simultaneously. During such instances, signals from specific peripheral devices may automatically be given priority over signals from other peripheral devices. For example, signals from VCR 130 and DVD 120 may be given priority over signals from cable/satellite receiver unit 150. The priority of peripheral devices may be user configurable.

### Conclusion

Systems and methods consistent with the present invention provide a connector unit that facilitates the connection of peripheral components, such as DVD players/recorders, VCRs, video game consoles, cable and/or satellite receivers, computers, surround sound systems, camcorders, and the like, to a television. The connector unit separates the connectors for the different peripheral components and provides easy-to-understand labeling (and/or color coding) to aid users (especially unskilled users) in properly connecting and disconnecting peripheral components. Moreover, in those situations where several peripheral components are connected to the television, connector unit 170 aids in keeping the cables connecting the peripheral devices to the television from getting tangled and improves the overall appearance of the entertainment system.

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. For example, while the above description focused on interconnecting components using coaxial cables, 3 RCA cables, and S video cables, the present invention is equally applicable to the use of other types of cables. In addition, the present invention is not limited to interconnecting a television and peripheral components using a single connector unit, as illustrated above. Multiple connector units may be connected together to allow a greater number of entertainment components to be interconnected. Multiple connector units may be connected by, for example, connecting the connector units together using a coaxial cable, 3 RCA cable, S video cable, or some other conventional type of cable.

The above implementations can be implemented in software, hardware, or a combination of software and hardware. Thus, the present invention is not limited to any specific combination of hardware circuitry and software.

While a series of acts has been described with regard to FIG. 5, the order of the acts may be varied in other implementations consistent with the present invention. Moreover, non-dependent acts may be implemented in parallel. No element, act, or instruction used in the description of the present application should be construed as critical or essential to the invention unless explicitly described as such. Also, as used herein, the article “a” is intended to include one or more items. Where only one item is intended, the term “one” or similar language is used.

The scope of the invention is defined by the claims and their equivalents.

What is claimed is:

1. A system for routing signals in an entertainment system, comprising:
one or more television connectors configured to receive one or more connector cables from a television;
one or more cable/satellite receiver connectors configured to receive one or more connector cables from one of a cable receiver and satellite receiver;
one or more video cassette recorder (VCR) connectors configured to receive one or more connector cables from one or more VCRs;
one or more digital video disk (DVD) connectors configured to receive one or more connector cables from a DVD device; and
a converter unit configured to format signals for transmission amongst the television, the cable or satellite receiver, the one or more VCRs, and the DVD device.

2. The system of claim 1 further comprising:
at least one other connector configured to receive a connector cable from one or more of a computer, a video game console, a camcorder, and a surround sound system.

3. The system of claim 1 wherein the one or more television connectors, the one or more cable/satellite receiver connectors, the one or more VCR connectors, and the one or more DVD connectors are separately located on the system.

4. The system of claim 3 further comprising:
labeling to identify the connectors.

5. The system of claim 1 wherein the one or more television connectors, the one or more cable/satellite receiver connectors, the one or more VCR connectors, and the one or more DVD connectors are color coded differently.

6. The system of claim 1 wherein the converter unit includes:
a first converter configured to format signals for transmission between an S video cable and a coaxial cable,
a second converter configured to format signals for transmission between an S video cable and a 3 RCA cable, and
a third converter configured to format signals for transmission between a 3 RCA cable and a coaxial cable.

7. The system of claim 6 wherein the converter unit further includes:
a converter bypass unit configured to bypass the formatting of signals.

8. A system for routing signals in an entertainment system, comprising:
one or more first connectors configured to receive one or more connector cables from a first entertainment component;
one or more second connectors configured to receive one or more connector cables from a second entertainment component;
one or more third connectors configured to receive one or more connector cables from a third entertainment component; and
a converter unit configured to:
convert signals received via one of the first, second, and third connectors from a first format to one or more different formats, and
route the signals between the first, second, and third connectors.

9. The system of claim 8 wherein the converter unit is further configured to:
convert signals received via one of the first, second, and third connectors from the first format to more than one second format.

10. The system of claim 8 wherein the first entertainment component includes a television, and
wherein the one or more first connectors include at least one of a coaxial cable connector, a RCA cable connector, and an S video cable connector.

11. The system of claim 10 wherein each of the second entertainment component and third entertainment component includes at least one of a digital video disk (DVD) device, a video cassette recorder, a video game console, a cable receiver, a satellite receiver, a computer device, a surround sound system, and a camcorder.

12. The system of claim 8 further comprising:
one or more additional connectors configured to receive one or more connector cables from one or more additional entertainment components.

13. A method for interconnecting a plurality of components in an entertainment system, comprising:
connecting a television to a connector unit;
connecting the plurality of components to the connector unit; and
routing signals between the plurality of components and the television via the connector unit.

14. The method of claim 13 wherein the plurality of components include one or more of a digital video disk (DVD) device, a video cassette recorder, a video game console, a cable receiver, a satellite receiver, a computer device, a surround sound system, and a camcorder.

15. The method of claim 13 wherein the routing includes:
formatting signals from a first format to a second different format.

16. The method of claim 13 wherein the connecting a television includes:
connecting the television to the connector unit using one of a coaxial cable, an S video cable, and a 3 RCA cable.

17. The method of claim 16 wherein the connector unit includes a group of dedicated connectors.

18. The method of claim 17 wherein the connecting a television further includes:
connecting the television to a dedicated television connector.

19. The method of claim 13 wherein the connecting two or more components to the connector unit includes:
connecting each of the two or more components using one or more of a coaxial cable, an S video cable, and a 3 RCA cable.

20. A method for routing signals via a connector unit configured to interconnect a television and a plurality of components, the method comprising:
receiving one or more signals in a first format from one of the plurality of components;
converting the one or more signals from the first format to one of a plurality of different formats; and
transmitting the one or more signals in the different format to the television.

21. The method of claim 20 wherein the plurality of different formats include a coaxial cable format, a RCA cable format, and an S video cable format.

22. The method of claim 20 wherein the plurality of components include one or more of a digital video disk (DVD) device, a video cassette recorder, a video game console, a cable receiver, a satellite receiver, a computer device, a surround sound system, and a camcorder.

23. A connector unit for use with an entertainment system comprising a television and a plurality of components, comprising:
at least two first connectors, each of the first connectors configured to receive a different type of signal cable from the television;
at least one second connector configured to receive a signal cable from one of the plurality of components; and
at least one third connector configured to receive a signal cable from a second of the plurality of components.

24. The connector unit of claim 23 wherein the at least two first connectors include connectors for receiving two or more of a coaxial cable, a RCA cable, and an S video cable.
